(19) United States
(12) Patent Application Publication
(10) Pub. No.: US 2003/0214113 A1
(43) Pub. Date: Nov. 20, 2003

(54) Vehicle having independently articulating rear frame members

(76) Inventor: Todd Bank, Los Angeles, CA (US)

Correspondence Address: Aaron T. Borrowman, KELLY BAUERSFELD LOWRY & KELLEY, LLP, Suite 1650, 6320 Canoga Avenue, Woodland Hills, CA, 91367, US

(21) Appl. No.: 10/428,816

(22) Filed: May 2, 2003

Related U.S. Application Data
(60) Provisional application No. 60/377,424, filed on May 2, 2002.

(51) Int. Cl. B62K 1/00

(52) U.S. Cl. 280/282

(57) ABSTRACT

A vehicle having a front frame section and rear frame sections which are pivotally attached to the front frame section and adapted to move along a vertical plane independent of one another. The vehicle includes a steering assembly connected to the front frame section. Upper and lower stops extend from the front frame section and are engageable with the rear frame sections to limit the vertical movement thereof. Movement facilitators, such as wheels or ski members, are operably connected to the vehicle so as to interface with the riding surface and provide movement to the vehicle.

### RELATED APPLICATION

This application claims priority from U.S. Provisional Application Serial No. 60/377,424, filed May 2, 2002.

### BACKGROUND OF THE INVENTION

The present invention relates generally to chariot-style vehicles. More particularly, the present invention relates to a chariot-style vehicle having an articulated frame that allows the center of gravity of the vehicle to move laterally, such as when negotiating a sharp curve.

There are known a number of different types of three-wheeled vehicles. With the exception of three-wheeled vehicles having engines and other automotive features which are very complex and expensive, the majority of three-wheeled vehicles include a single frame. Such conventional three-wheeled vehicles are not suited for non-pavement terrain, and particularly for traveling down hillsides or mountain trails. With the exception of the front fork for steering, all components of such conventional three-wheeled vehicles are fastened securely to the frame. As a result, the three-wheeled vehicle is rather vulnerable to overturn when it is negotiating a curve while cruising at a high speed. Such an overturn of the three-wheeled vehicle as described above is caused by an imbalance brought about by the combined effect of a centrifugal force of the rider and the frame, as well as a thrust of the rear wheels in motion. Such conventional three-wheeled vehicles also are vulnerable to overturn when traversing uneven terrain.

Accordingly, there is a continuing need for a three-wheeled vehicle that is designed to be operated and ridden on trails and other irregular surfaces, and particularly designed for operation on hillsides and mountain trails, and ski slopes. The present invention fulfills this need and provides other related advantages.

### SUMMARY OF THE INVENTION

The present invention resides in a vehicle having independently articulating rear frame members which is particularly adapted for travel along uneven and irregular surfaces while remaining stable. The vehicle generally comprises a front frame section having first and second rear frame sections pivotally attached thereto. The first and second rearframe sections are adapted to move along a vertical plane independent of one another.

A steering assembly is operably connected to the front frame section. Typically, the steering system includes a handle bar rotatably connected to the front frame section.

A front movement facilitator, such as a wheel or ski member, is operably connected to the steering assembly. In the case of a wheel, the wheel is rotatably connected to a fork of the steering assembly. The front movement facilitator is interfaceable with the riding surface to support the front frame section on the riding surface and provide movement to the vehicle. Similarly, the first and rear frame sections have movement facilitators operably connected thereto, typically in the form of wheels or ski members.

The first and second frame sections include rider supports, typically foot platforms attached to the first and second rear frame sections and adapted to support a rider's foot thereon.

The vehicle includes upper stops extending from the front frame section and engageable with the first and second rear frame sections to limit the upward movement of the first and second rear frame sections. The upper stops preferably have shock dampening characteristics and may be comprised of a resiliently flexible elastomeric material.

The vehicle also includes lower stops extending from the front frame section and engageable with the first and second rear frame sections to limit the downward movement of the rear frame sections. These stops preferably also have shock dampening characteristics and may be comprised of resiliently flexible elastomeric material.

In a particularly preferred embodiment, the vehicle includes a brake system. Such a brake system may comprise brake levers at each hand grip of the handle bar for selectively braking the first or second rear wheels, which not only causes the vehicle to brake, but also can be used to steer the vehicle.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a vehicle embodying the present invention having rear articulating frame section members;

FIG. 2 is a side perspective view of the vehicle of the present invention at rest on a generally flat surface;

FIG. 3 is a side perspective view of the vehicle of the present invention, illustrating the vertical movement of the rear frame sections in response to an irregular riding surface;

FIG. 4 is a rear elevational view of the vehicle of the present invention in an upright position;

FIG. 5 is a rear elevational view of the vehicle angled, such as when turning;

FIG. 6 is a partially fragmented side perspective view of the interrelation between a front frame section and a rear frame section when the vehicle is at rest or riding along a generally horizontal and flat surface;

FIG. 7 is a partially fragmented side perspective view similar to

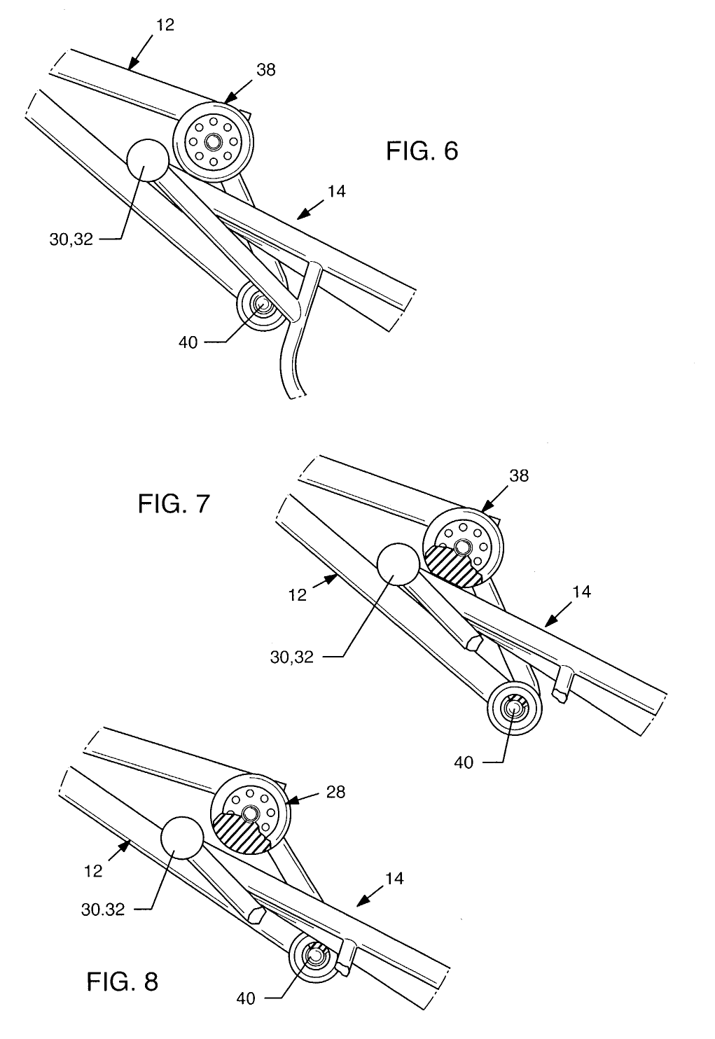

FIG. 6, illustrating the rearframe section being raised vertically and compressing an upper stop of the vehicle;

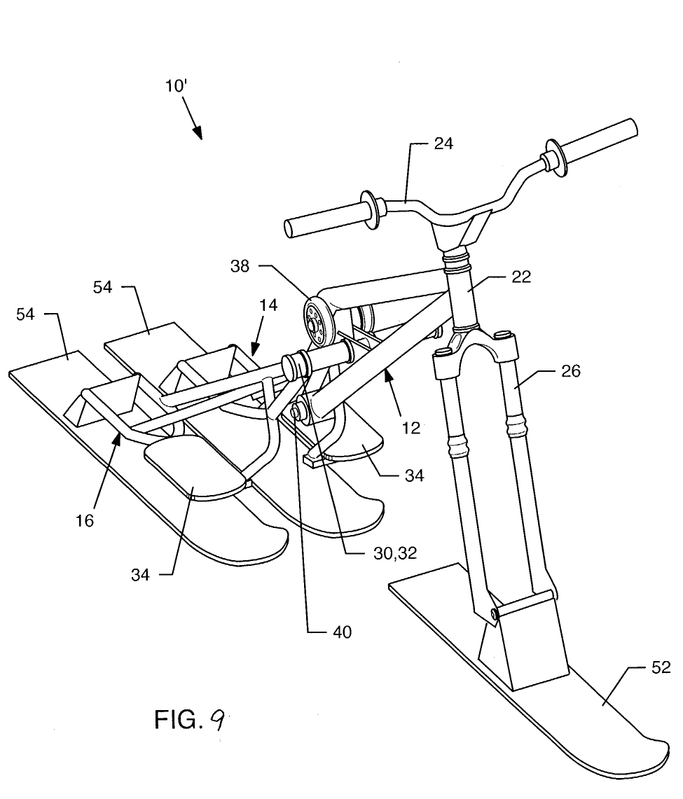

FIG. 8 is a partially fragmented side perspective view similar to FIGS. 6 and 7, illustrating the rear frame section moved downward into contact with a lower stop of the vehicle; and

FIG. 9 is a perspective view of the vehicle of the present invention having ski members attached thereto.

### DETAILED DESCRIPTION OF THE PREFERRED EMBODIMENTS

As shown in the accompanying drawings for purposes of illustration, the present invention resides in a vehicle, generally referred to by the reference number 10. As will described more fully herein, the unique aspects of the vehicle 10 of the present invention is that the rider stands thereupon and the frame is articulated such that rear supporting sections thereof pivot and move in response to forces applied thereto during operation of the vehicle 10.

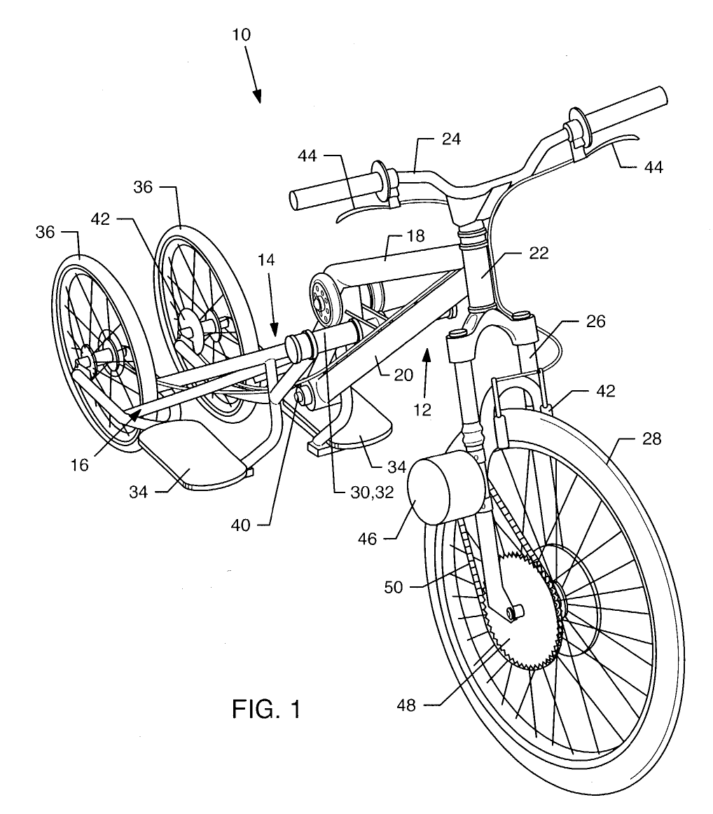

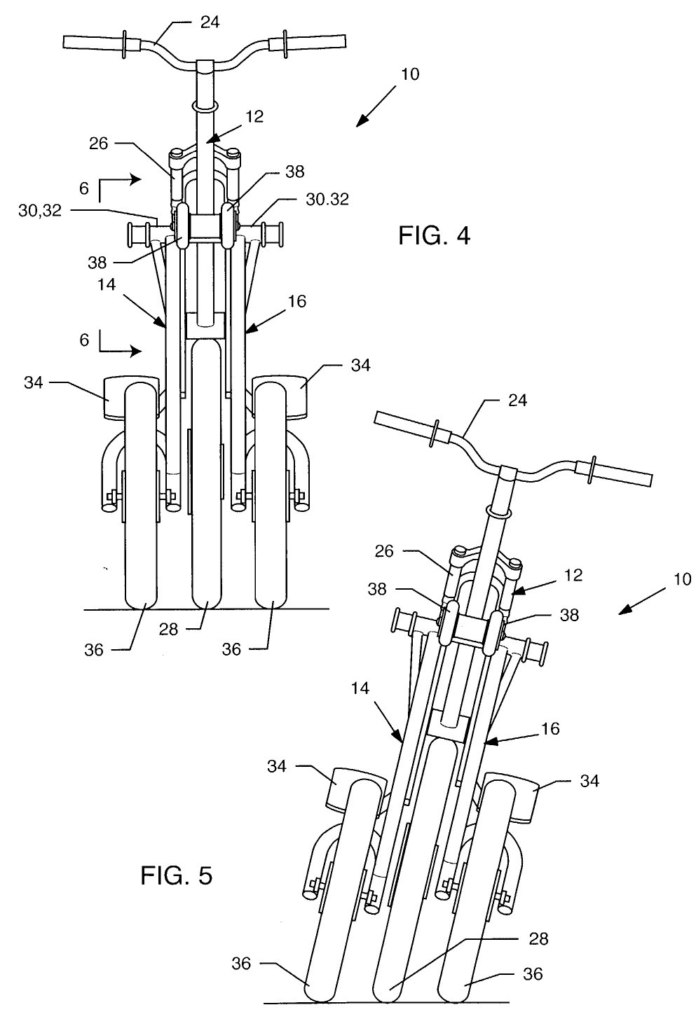

With reference to FIGS. 1-3, the vehicle 10 includes a front frame section 12 and rear frame sections 14 and 16 which are pivotally attached to the front frame section 12 so as to independently articulate, as will be more fully discussed herein. The front frame section 12 is typically comprised of tubes 18 and 20 similar to that of a front portion of a bicycle or the like. The front frame section 12 includes a steering system operably connected to a front movement facilitator which serves to support the front frame section on a riding surface and provide movement to the vehicle. As illustrated in FIGS. 1-5, in a particularly preferred embodiment, the front frame section 12 includes a head tube 22 having a handle bar 24 and fork assembly 26 rotatably attached thereto in conventional fashion using bearing and the like similar to a bicycle. A wheel 28 is rotatably attached to the fork 26. As the vehicle 10 of the present invention is particularly adapted for uneven and downhill trails, the fork 26 is preferably in the form of a mountain bike shock fork or the like to provide dampening and reduce the forces applied to a rider's hands and arms. It is also contemplated that two wheels be operably connected to the steering system.

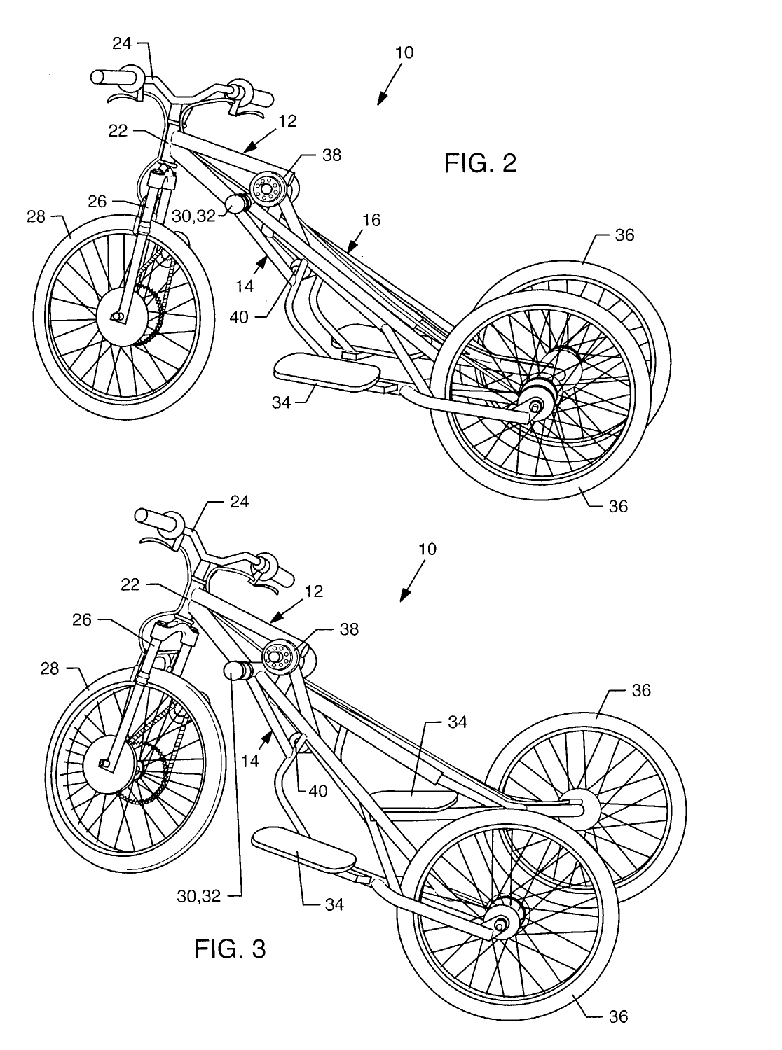

With continuing reference to FIGS. 1-5, as discussed above, the rear frame sections 14 and 16 are pivotally attached to the front frame section 12. Such connection can be made by any means which are known in the art such that the sections 14 and 16 can independently pivot and articulate relative to one another in a generally vertical radial path. The rear frame sections or legs 14 and 16 are laterally spaced from one another and are generally parallel to one another when resting on a flat surface, as illustrated in FIGS. 1 and 2.

In a particularly preferred embodiment, rods 30 extend outwardly from the front frame section 12 and are configured to receive a sleeve 32 of the rear frame sections 14 and 16 thereover such that the sleeve 32 can rotate about the rod 30. The sleeve 32 is bolted, or otherwise attached, to the rods 30. Bearings, lubrication and the like may be implemented as necessary so that the sleeves 32 can rotate freely about rods 30, and thus allow the rear frame sections 14 and 16 to pivot.

The rear frame sections 14 and 16 are comprised of a framework having sufficient strength and durability to support an adult thereon. Typically, the rear frame sections 14 and 16 are comprised of tubes, such as those used in bicycles and the like. The rearframe sections 14 and 16 extend at a generally downward angle from the pivotal connection 30, 32 to rider foot supports 34. The foot supports 34 are adapted to support a rider's foot thereon, and are typically generally planar and parallel to the flat riding surface. The foot supports 34 may include bindings, foot straps, etc. to accommodate riders of different size, and enable the rider to more securely be positioned on the vehicle 10 and prevent his or her feet from slipping off the foot platforms 34 when traveling along particularly steep or uneven trails. A seat could also be provided as attaching a seat to the front frame section, such that the rider could sit on the seat and place his or her feet on the platforms 34.

A movement facilitator is operably connected to each rear frame section 14 and 16 which is interfaceable with the riding surface to support the rear frame sections 14 and 16 and provide movement to the vehicle 10. As illustrated in FIGS. 1-5, rear wheels 36 are operably and rotatably connected to the rear frame sections 14 and 16 so as to provide movement to the vehicle 10 and support the rear frame sections 14 and 16.

A particularly unique aspect of the present invention, as illustrated in FIGS. 3-5, is that the left and right rear frame sections 14 and 16 independently articulate and pivot about rods 30. This pivoting point between the front frame section 12 and rear frame sections 14 and 16 allows the rider of the vehicle 10 to lean his or her center of gravity to the left or right, as illustrated in FIG. 5, giving traction to the rear wheels 36, similar to skiing. Thus, as the rider leans the vehicle 10 left or right, each rear frame member 14 and 16 pivots the same direction as the bottom of the rider's foot. This allows the foot to stay flat on the support 34 and not slide off. Also, this action allows the rear wheels 36 to lean left or right with the rider's body. As a result, the centrifugal force exerted on the rider of the vehicle is cancelled out by the tilting of the left or right rear frame member 14 or 16 when the vehicle 10 is in motion and negotiating a curve. This action allows the vehicle 10 to have three wheels 28 and 36 that all tilt and remain in line with the rider's center of gravity, as shown in FIG. 5, preventing the vulnerability of overturning the vehicle 10 as with prior art three-wheeled vehicles. Also, as illustrated in FIG. 3, when experiencing bumps, holes, or other irregular surfaces on a path, the rear frame sections 14 and 16 pivot in response to the rear wheel 36 coming into contact with such irregular surface causing the rear frame section 14 or 16 to move downwardly or upwardly in response, and preventing the overturning of the vehicle 10.

So that the vehicle 10 rests in an upright position, as shown in FIG. 1, and also to limit the upward travel of the rear frame sections 14 and 16, upper stops 38 extend from the upper frame section 12 and are positioned such that the rear frame sections 14 and 16 come into contact with the respective stops 38, as illustrated in FIG. 6. Preferably, the upper stops 38 have shock absorbing and dampening qualities. It has been found that a particularly useful stop comprises an in-line skate wheel which has a durable rubber/elastomeric outer ring that can be compressed slightly due to the rider's weight and force applied thereto during operation of the vehicle 10, as illustrated in FIG. 7, and lessen the force imparted to the rider of the vehicle 10. Of course, any shock or dampening mechanism can be implemented into the present invention. The stops 38 may comprise shock absorbing devices such as those used on mountain bikes or motorcycles. Such shock absorbing devices could include rubber, springs, compressed air, etc. so long as the upward travel of the rear frame sections 14 and 16 are limited, and preferably provide shock dampening qualities. Such stop/dampening mechanism could be adjustable such that the rider would be able to adjust the rigidity and pivoting motion of the rear frame sections 14 and 16 to accommodate for relatively smooth trails, in which the rear sections 14 and 16 would move very little, and the uneven and rocky trails in which the rear sections 14 and 16 would be allowed to move more freely so as to retain control of the vehicle 10. The ability to tension the dampening mechanism/stop would also enable the rider to push the vehicle 10 up a hill more easily when anymore tensioned mode, and release the tension in order to travel downwardly on the trail to have the benefit of the shock absorbing or dampening effect.

Lower stops 40 also extend outwardly from the upper frame section 12 so as to be positioned below the rear frame sections 14 and 16 to limit the downward pivoting motion of each section, as illustrated in FIG. 8. Preferably, the lower stops 40 have shock dampening characteristics or qualities. Typically, the lower stops 40 will have a resiliently flexible and durable elastomeric sleeve or end so that as each rear section 14 and 16 comes into contact with its respective lower stop 40, the elastomeric material serves to reduce the shock and force exerted on each lower frame section member 14 and 16 and also to reduce the strain on the rider of the vehicle 10. The upper and lower stops 38 and 40 prevent the rear frame sections 14 and 16 from moving excessively, thus serving to stabilize the rider while allowing the vehicle 10 to lean and pivot. Although the stops 38 and 40 illustrated in the drawings are of simple construction and relatively inexpensive, it will be appreciated by those skilled in the art that other shock dampening mechanisms and stops could be implemented into the present invention to satisfy the same needs.

The vehicle 10 preferably includes a brake system, including either front or rear wheel brakes 42, which can be of any conventional type including disc or caliber, which are operably connected to a hand lever 44 positioned on the handle bar 24 as is well-known in the art. In a particularly preferred embodiment, both of the rearwheels 36 have independently operated brakes 42 such that each wheel 36 may be selectively braked to enhance turning. For example, when turning left, the left rear wheel 36 could have braking force applied thereto such that the left rear wheel 36 would serve as a pivot point of sorts and the right rear wheel 36 would turn along a radial path such that a sharper turn could be accomplished. Thus, using the braking system, the rider could adjust the overall speed of the vehicle 10, as well as selectively braking to enhance turning.

In one embodiment, the vehicle 10 is manually powered by pushing off with a foot, or riding the vehicle 10 on a downhill trail or the like. When riding on a downward trail, the rider places his or her feet on the supporting foot platforms 34, faces forward, and grasps the hand grips of the handle bar 24. The rider can then push off with the foot to propel the vehicle 10 down the hillside trail, after which gravity is used to ride to the bottom of the hillside. The rider is able to lean into turns using his or her body, causing the inner rear frame member 14 or 16 to pivot such that the entire vehicle leans into the curve, such as that illustrated in FIGS. 3 and 5. The handle bar 24 and front tire 28 can be turned so as to steer the vehicle 10. The vehicle 10 of the present invention allows snow skiers to mimic skiing techniques and movement on hillside trails during the warm spring or summer months when snow is not on the ground. The vehicle 10 of the present invention also provides an alternative amusement device to those who enjoy mountain biking.

With particular reference to FIG. 1, in addition to being propelled by the occupant or gravity, a motor or engine 46 may be associated with the vehicle 10 so that the vehicle 10 can be used to travel along flat or inclined surfaces. The addition of the motor 46 would allow the vehicle 10 to be ridden along sidewalks, meandering trails and the like. In a particularly preferred embodiment, as illustrated, an electric motor 46 is mounted upon the front fork 26 to drive the front wheel 28 of the vehicle 10. This can be accomplished by interconnecting a gear 48 fixed to the wheel axle to the electric motor 46 with a linkage member 50, in the form of a chain or the like. A throttle button or lever could be positioned at the handle bar 24 to control the torque provided to the front wheel 28 by the motor 46. Of course, the motor 46 could be operably connected to either rear wheel 36 as well. It is contemplated that the motor could be engaged and disengaged quite readily such that the motor 46 could be used to propel the vehicle 10 on generally flat or inclined surfaces, yet disengage when the vehicle travels on a decline. This will allow the rider to travel down the mountain trail by gravity, yet when reaching the base of the mountain, engage the electric motor 46 so as to drive the vehicle to the trail lift or his or her car. Of course, incorporating the motor 46 allows the vehicle 10 of the present invention to serve as a source of transportation as well. In this case, the vehicle 10 could include any necessary cages, lights, reflectors, turn signals, etc. to render the vehicle 10 convenient and safe for such transportation purposes.

With particular reference now to FIG. 9, the vehicle 10 of the present invention can use other movement facilitators than wheels. One such vehicle 10′ is illustrated in FIG. 8 and includes a front ski member 52 operably attached to the front fork 26, and rear ski members 54 attached to the rear frame sections 14 and 16 to enable the vehicle 10′ to travel along ski slopes or frozen surfaces. The rear frame sections 14 and 16 are connected to the front frame section 12 as described above such that the rear frame sections 14 and 16 independently articulate to provide the benefits discussed above. Thus, the vehicle 10′ is less prone to tipping over due to irregular and uneven surfaces.

It is contemplated that other movement facilitators could also be implemented into the vehicle 10 of the present invention such as tracks used in snowmobiles or the like and which could be either freely rotatable with respect to the vehicle 10, or driven by electric motors or the like. In all instances, the pivoting arrangement between the rear sections 14 and 16 and front section 12 of the vehicle frame would operate as described in detail above.

Although several embodiments have been described in detail for purposes of illustration, various modifications may be made without departing from the scope and spirit of the invention. Accordingly, the invention is not to be limited, except as by the appended claims.

What is claimed is:

1. A vehicle, comprising:
a front frame section;
a steering assembly operably connected to the front frame section;
a front movement facilitator operably connected to the steering assembly and interfaceable with a riding surface to support the front frame section on the riding surface and provide movement to the vehicle;
a first rear frame section pivotally attached to the front frame section and adapted to move along a vertical plane, the first rear frame section including a rider support;
a first rear movement facilitator operably connected to the first rear frame section and interfaceable with the riding surface to support the first rear frame section on the riding surface and provide movement to the vehicle;
a second rear frame section pivotally attached to the front frame section so as to move along a vertical plane independent of the first rear frame section and including a rider support; and
a second rear movement facilitator operably connected to the second rear frame section and interfaceable with the riding surface to support the second rear frame section on the riding surface and provide movement to the vehicle.

2. The vehicle of claim 1, wherein the steering system includes a handlebar rotatably connected to the front frame section and operably connected to the front movement facilitator.

3. The vehicle of claim 2, wherein the front movement facilitator comprises a wheel rotatably connected to a fork of the steering assembly.

4. The vehicle of claim 2, wherein the front movement facilitator comprises a ski member.

5. The vehicle of claim 1, wherein the first and second rear frame front movement facilitators comprise wheels rotatably attached to the first and second rear frame sections.

6. The vehicle of claim 1, wherein the first and second rear frame front movement facilitators comprise ski members attached to the first and second rear frame sections.

7. The vehicle of claim 1, wherein the rider support of the first and second rear frame sections comprise foot platforms attached to the first and second rear frame sections and adapted to support a rider's foot thereon.

8. The vehicle of claim 1, including lower stops extending from the front frame section and engage able with the first and second rear frame sections to limit the downward movement of the first and second rear frame sections.

9. The vehicle of claim 8, wherein the lower stops have shock dampening characteristics.

10. The vehicle of claim 9, wherein the lower stops are comprised of a resiliently flexible elastomeric material.

11. The vehicle of claim 1, including upper stops extending from the front frame section and engageable with the first and second rear frame sections to limit the upward movement of the first and second rear frame sections.

12. The vehicle of claim 11, wherein the upper stops have shock dampening characteristics.

13. The vehicle of claim 12, wherein the upper stops are comprised of a resiliently flexible elastomeric material.

14. The vehicle of claim 1, including a brake system operably connected to at least one of the front movement facilitator and rear frame movement facilitators.

15. A vehicle, comprising:
a front frame section;
a steering assembly including a handlebar and fork rotatably connected to the front frame section;
a front wheel rotatably connected to the fork of the steering assembly and interfaceable with a riding surface to support the front frame section on the riding surface and provide movement to the vehicle;
a first rear frame section pivotally attached to the front frame section and adapted to move along a vertical plane, the first rear frame section including a rider support comprising a foot platform adapted to support a rider's foot thereon;
a wheel rotatably connected to the first rear frame section and interfaceable with the riding surface to support the first rearframe section on the riding surface and provide movement to the vehicle;
a second rear frame section pivotally attached to the front frame section so as to move along a vertical plane independent of the first rear frame section and including a rider support comprising a foot platform adapted to support a rider's foot thereon;
a wheel rotatably connected to the second rear frame section and interfaceable with the riding surface to support the second rear frame section on the riding surface and provide movement to the vehicle;
lower stops extending from the front frame section and engage able with the first and second rear frame sections to limit the downward movement of the first and second rear frame sections; and
upper stops extending from the front frame section and engage able with the first and second rear frame sections to limit the upward movement of the first and second rear frame sections.

16. The vehicle of claim 15, wherein the lower stops have shock dampening characteristics.

17. The vehicle of claim 16, wherein the lower stops are comprised of a resiliently flexible elastomeric material.

18. The vehicle of claim 15, wherein the upper stops have shock dampening characteristics.

19. The vehicle of claim 18, wherein the upper stops are comprised of a resiliently flexible elastomeric material.

20. The vehicle of claim 18, including a brake system operably connected to at least one of the wheels.

21. A vehicle, comprising:
a front frame section;
a steering assembly including a handlebar rotatably connected to the front frame section;
a front ski member operably connected to the steering assembly and interfaceable with a riding surface to support the front frame section on the riding surface and provide movement to the vehicle;
a first rear frame section pivotally attached to the front frame section and adapted to move along a vertical plane, the first rear frame section including a rider support comprising a foot platform adapted to support a rider's foot thereon;
a first rear ski member operably connected to the first rear frame section and interfaceable with the riding surface to support the first rear frame section on the riding surface and provide movement to the vehicle;
a second rear frame section pivotally attached to the front frame section so as to move along a vertical plane independent of the first rear frame section and including a rider support comprising a foot platform adapted to support a rider's foot thereon;
a second rear ski member operably connected to the second rear frame section and interfaceable with the riding surface to support the second rear frame section on the riding surface and provide movement to the vehicle;
lower stops extending from the front frame section and engage able with the first and second rear frame sections to limit the downward movement of the first and second rear frame sections; and
upper stops extending from the front frame section and engage able with the first and second rear frame sections to limit the upward movement of the first and second rear frame sections.

22. The vehicle of claim 21, wherein the lower stops have shock dampening characteristics.

23. The vehicle of claim 22, wherein the lower stops are comprised of a resiliently flexible elastomeric material.

24. The vehicle of claim 21, wherein the upper stops have shock dampening characteristics.

25. The vehicle of claim 24, wherein the upper stops are comprised of a resiliently flexible elastomeric material.
